(19) United States
(12) Patent Application Publication
(10) Pub. No.: US 2022/0276697 A1
(43) Pub. Date: Sep. 1, 2022

(54) Apparatus and method

(71) Applicant: Sarah Saunders, Didsbury (GB)

(72) Inventor: Sarah Saunders, Didsbury (GB)

(21) Appl. No.: 17/652,724

(22) Filed: Feb. 28, 2022

(30) Foreign Application Priority Data
Feb. 26, 2021 (GB) 2102809.7

(51) Int. Cl. G06F 3/01

(52) U.S. Cl. CPC G06F 3/011; G06F 2203/012

(57) ABSTRACT

An apparatus 10 comprises: a harness 110 for suspending, at least in part, a user U, wherein the harness 110 comprises a set of straps 120, including a first strap 120A, attachable to respective limbs L of the user U; a set of sensors 130, including a first sensor 130A, configured to output a set of output signals, including a first signal, related to the user U; and a controller 140 communicatively coupleable to a virtual reality, VR, headset H of the user U; wherein the controller 140 is configured to: to transmit the set of output signals to the VR headset H.

### FIELD

The present invention relates to virtual reality.

### BACKGROUND TO THE INVENTION

Generally, virtual reality (VR) is a simulated experience, providing a user with a simulated (and optionally interactive) environment, typically generated from a model and/or from images acquired from a real-world environment. VR has applications including entertainment and education. VR systems, for example including VR headsets or multiple projectors, display 2D or 3D images of the simulated environment. Audio may also be provided. During immersive VR, as the user changes their viewpoint, corresponding images of the simulated environment are displayed accordingly, providing up to omnidirectional viewing.

However, the user is typically constrained to changing only their viewpoint from a relatively fixed position, for example by moving, such as rotating and/or tilting, their head and/or turning their body so as to move their head while generally remaining otherwise relatively stationary. Particularly, moving within the simulated environment by moving within the real-world environment whilst wearing a VR headset, for example, may not be possible since the real-world environment may not be compatible with the simulated environment. Furthermore, when moving in the real-world environment whilst wearing the VR headset, the user is unaware of obstacles or dangers in the real-world environment and thus may be unsafe. Hence, moving within the simulated environment may be problematic, thereby limiting the experience provided by the VR and/or interaction with the simulated environment.

Hence, there is a need to improve VR.

### SUMMARY OF THE INVENTION

It is one aim of the present invention, amongst others, to provide an apparatus which at least partially obviates or mitigates at least some of the disadvantages of the prior art, whether identified herein or elsewhere. For instance, it is an aim of embodiments of the invention to provide an apparatus that enhances an experience provided by VR and/or interaction with a simulated environment thereof.

A first aspect provides an apparatus comprising:

a harness for suspending, at least in part, a user, wherein the harness comprises a set of straps, including a first strap, attachable to respective limbs of the user;
a set of sensors, including a first sensor, configured to output a set of output signals, including a first signal, related to the user; and
a controller communicatively coupleable to a virtual reality, VR, headset of the user;
wherein the controller is configured to:
to transmit the set of output signals to the VR headset.

A second aspect provides an apparatus comprising:

a harness for suspending, at least in part, a user, wherein the harness comprises a set of straps, including a first strap, attachable to respective limbs of the user;
a set of actuators, including a first actuator, arranged to adjust respective lengths of the set of straps; and
a controller communicatively coupleable to a virtual reality, VR, headset of the user;
wherein the controller is configured to:
receive a set of input signals, including a first input signal, from the VR headset; and
control the first actuator to adjust a length of the first strap, responsive to the first input signal.

A third aspect provides virtual reality, VR, headset configured to transmit a set of input signals, including a first input signal, to an apparatus according to the first aspect and/or the second aspect.

A fourth aspect provides a kit comprising an apparatus according to the first aspect and/or the second aspect and a VR headset according to the third aspect.

A fifth aspect provides a method of virtual reality, VR, of an apparatus according to the first aspect, the method comprising:

outputting, by the set of sensors including the first sensor, the set of output signals, including the first signal; and
transmitting, by the controller, the set of output signals to the VR headset.

A sixth aspect provides a method of virtual reality, VR, of an apparatus according to the second aspect, the method comprising:

receiving, by the controller, the set of input signals, including the first input signal, from the VR headset; and
controlling, by the controller, the first actuator to adjust the length of the first strap, responsive to the first input signal.

A seventh aspect computer comprising a processor and a memory configured to implement a method according to the fifth aspect and/or the sixth aspect, a computer program comprising instructions which, when executed by a computer comprising a processor and a memory, cause the computer to perform a method according to the fifth aspect and/or the sixth aspect, or a non-transient computer-readable storage medium comprising instructions which, when executed by a computer comprising a processor and a memory, cause the computer to perform a method according to the fifth aspect and/or the sixth aspect.

### DETAILED DESCRIPTION OF THE INVENTION

According to the present invention there is provided an apparatus, as set forth in the appended claims. Also provided is a VR headset, a kit, a method, a computer, a computer program and a non-transient computer-readable storage medium. Other features of the invention will be apparent from the dependent claims, and the description that follows.

### Apparatus

A first aspect provides an apparatus comprising:

a harness for suspending, at least in part, a user, wherein the harness comprises a set of straps, including a first strap, attachable to respective limbs of the user;
a set of sensors, including a first sensor, configured to output a set of output signals, including a first signal, related to the user; and
a controller communicatively coupleable to a virtual reality, VR, headset of the user;
wherein the controller is configured to:
to transmit the set of output signals to the VR headset.

In this way, the user may move relatively freely whilst suspended in the harness, allowing the user to simulate moving in a simulated environment provided by the VR, as displayed by the VR headset of the user. For example, the user may turn their body as well as moving their head and/or limbs, thereby better replicating moving in the real-world environment. However, since the user is suspended in the harness, obstacles or dangers in the real-world environment are eliminated, thereby providing a safe simulated experience for the user. Furthermore, the harness includes the set of sensors that output the set of output signals related to the user. These output signals are transmitted to the VR headset by the controller, thereby providing input or feedback from the user to the VR. In this way, the experience provided by VR and/or interaction with the simulated environment thereof is enhanced for the user. Furthermore, the apparatus is relatively simple (i.e. having relatively few components or parts), thereby reducing a cost and/or complexity thereof. In one example, the apparatus consists of the harness, the set of sensors, optionally a set of actuators, the controller communicatively coupleable to the VR headset, a power supply and optionally, a frame. In this way, manufacture, distribution and storage of the apparatus is facilitated while use thereof is simplified. For example, the harness, having the set of sensors, controller and power supply attached thereto, may be stored conveniently by the user and subsequently, worn and used by the user.

### Harness

The apparatus comprises the harness for suspending, at least in part, the user. It should be understood that the harness is suitable for suspending the user, for example from a suspension or attachment point. In one example, the harness comprises a waist or climbing harness, having an adjustable waistbelt and a pair of adjustable leg loops attached thereto. Waist harnesses are known. In one example, the harness comprises a full body harness, having an adjustable waistbelt and a pair of adjustable leg loops, a pair of shoulder straps and optionally a chest strap attached thereto. Full body harnesses are known. In contrast to a waist harness, a full body harness permits safe inversion of the user.

### Straps

The harness comprises the set of straps, including the first strap, attachable to the respective limbs of the user. It should be understood that the set of straps is different and separate from the leg loops of waist harnesses and full body harnesses. That is, the harness further comprises the set of straps, for example in addition to the leg loops. It should be understood that the set of straps is formed from a flexible material, for example webbing.

In one example, the set of straps includes a second strap and the first strap and the second strap are attachable to respective upper or lower limbs of the user. In this way, the first and second strap may be attached to the user's arms or the user's legs.

In one example, the set of straps is attachable proximal distal ends of the respective limbs (i.e. legs and/or arms) of the user, for example proximal or at the wrists and/or ankles of the user. In one example, the set of straps includes the first strap and a second strap, attachable to respective wrists or ankles of the user. By attaching the set of straps to the wrists of the user, arm movements, including independent arm movements, of the user may be input into the VR, as described below. For example, throwing, catching and/or swimming of the suspended user may be input into the VR. By attaching the set of straps to the ankles of the user, leg movements, including independent leg movements, of the user may be input into the VR, as described below. For example, walking, running and/or jumping of the suspended user may be input into the VR. In one example, the set of straps includes the first strap, a second strap, a third strap and a fourth strap attachable to respective wrists and ankles of the user.

In one example, the first strap comprises one or more adjustable and/or releasable cuff(s), for attaching around a limb, for example a wrist, forearm and/or upper arm or an ankle, calf and/or thigh of the user.

In one example, the first strap comprises a stirrup, for the user's foot.

### Sensors

The apparatus comprises the set of sensors, including the first sensor, configured to output the set of output signals, including the first signal, related to the user. It should be understood that the set of sensors is configured to sense a measurable physical property related to the user, including to the harness worn by the user.

In one example, the first sensor comprises and/or is a force sensor, adapted to sense a force applied, at least in part, by the user on the first strap. In this way, the force applied by the user on the first strap may be input into the VR. In this way, a speed of movement of the user resulting in the applied force may be calculated, for example by the controller and/or by the VR, whereby walking and running, for example, may be distinguished. In this way, interaction with the simulated environment may be improved. In one example, the force sensor or a plurality thereof is/are attached to respective stirrups and the sensed force(s) is/are used by the controller to calculate distance moved by a stride and/or jump height, for example within a VR landscape. In one example, the first sensor comprises and/or is a position sensor, as described below. In one example, the position sensor or a plurality thereof is/are attached to respective stirrups and the sensed position(s) adapted to sense a distance (i.e. a stride length) moved by the user and/or a first limb thereof. In one example, the controller is configured to calculate new co-ordinates of, for example, the user's avatar in VR, for example by multiplying the force(s) sensed by the force sensor(s) and the stride length. Force sensors include force cells; piezoelectric sensors; and strain gauges.

In one example, the first sensor comprises and/or is a position sensor, adapted to sense a position of the user and/or a first limb thereof. In this way, a position of the user in the simulated environment may be determined, for example by translation from the real-world environment. By repeatedly sensing the position of the user and/or first limb thereof, movement of the user and/or first limb thereof may be determined and included in the simulated environment. Position sensors include capacitive displacement sensors, eddy-current sensors; Hall effect sensors; inductive sensors; laser Doppler vibrometers (optical); linear variable differential transformers (LVDT); photodiode arrays; piezo-electric transducers (piezo-electric); position encoders such as: absolute encoders, incremental encoders, linear encoders, and rotary encoders; potentiometers; proximity sensors (optical); string potentiometers; and ultrasonic sensors.

In one example, the first sensor comprises and/or is an orientation sensor, adapted to sense an orientation of the user and/or the first limb thereof. In this way, an orientation (i.e. direction) of the user and/or the first limb thereof may be determined and included in the simulated environment. Orientation sensors include inertial measurement units; gyroscopes; and accelerometers.

In one example, the first sensor comprises and/or is a movement sensor, adapted to sense a movement of the user and/or the first limb thereof. In this way, a movement of the user and/or the first limb thereof may be determined and included in the simulated environment. Movement sensors include inertial measurement units; gyroscopes; and accelerometers.

In one example, the set of sensors includes a plurality of force, position, orientation and/or movement sensors, for example for and/or associated with each strap of the set thereof. In this way, forces applied by the user on the straps by the respective limbs and/or positions, orientations and/or movements of the respective limbs maybe input into the VR.

In one example, the set of sensors includes a second sensor, wherein the second sensor comprises and/or is a position sensor, an orientation sensor and/or a movement sensor, adapted to sense a position, an orientation and/or a movement of a first limb of the user.

In one example, the set of sensors is attached and/or integrated in the harness, for example on and/or in in the set of straps.

### Controller

The apparatus comprises the controller communicatively coupleable to the VR headset of the user and the controller is configured to transmit the set of output signals to the VR headset. In this way, input or feedback from the user may be input to the VR. In this way, the experience provided by VR and/or interaction with the simulated environment thereof is enhanced for the user.

It should be understood that the controller is communicatively coupled, for example wirelessly or via wires, to the set of sensors, for example unidirectionally. In one example, the controller comprises a processor and a memory.

In one example, the controller is communicatively coupleable to the VR headset wirelessly, for example via Bluetooth, or via wires, for example using a USB cable, for example unidirectionally or bidirectionally.

In one example, the controller is configured to receive a set of input signals, including a first input signal, from the VR headset. In this way, the controller may receive input signals from the VR headset to feedback from the simulated environment to the user, for example described below.

In one example, the controller includes a processor and a memory, an ASIC and/or a FPGA, configured to perform instructions to perform the methods according to the first aspect and/or the second aspect.

In one example, the controller is attached and/or integrated in the harness, for example on and/or in a waistbelt thereof.

### VR Headset

VR headsets are known. VR headsets include Oculus Quest®, Oculus Quest 2®, Oculus Rift®, Sony Playstation VR®, HTC Vive Cosmos®, Valve Index®, Windows Mixed Reality® and HP Reverb G2®. It should be understood that the VR headset generally comprises a display, for example a stereoscopic or an autosteroscopic display, communicatively coupled to a computer including a processor and a memory. It should be understood that the computer may be remote with respect to the display and that functions of the computer may be performed via a network, for example via client-server computing.

### Power Supply

In one example, the apparatus comprises a power supply, for example a battery, for providing electrical power to the sensors and/or the controller. In one example, the power supply is attached and/or integrated in the harness, for example on and/or in a waistbelt thereof. In one example, electrical power is obtained from the VR headset, for example via wires therefrom.

### Frame

In one example, the apparatus comprises a frame for suspending the harness therefrom. In this way, the user wearing the harness may be suspended from the frame c.f. suspended from a suspension point. In one example, the frame is arranged to allow the user to stand suspended above the ground and to lie suspended horizontally with arms outstretched. In one example, the frame has a height greater than or equal to that of the user, for example in a range from 1.5 m to 2.5 m. In this way, the user is suspended below, for example entirely below, a relatively higher suspension point or apex of the frame. In one example, the frame has a height less than that of the user, for example in a range from 1.0 m to 1.5 m. In this way, the user is suspended via the waist below a suspension point of the frame. It should be understood that the suspension point of the frame is above a centre of mass of the user.

In one example, the frame comprises a set of legs, for example 1, 2, 3, 4 or more legs. Generally, 3 or 4 legs are preferred, thereby reducing a complexity. In one example, the frame comprises one or more ties arranged to mutually tie the legs of the set thereof. In this way, structural integrity of the frame is improved.

In one example, the frame comprises and/or is a foldable or demountable frame. In this way, the frame may be folded or demounted for storage, for example.

In one example, the frame comprises a pivot for rotation, for example a freely rotating pivot, of the suspended harness about 1, 2 or 3 mutually orthogonal axes. In this way, the user may rotate about 1, 2 or 3 mutually orthogonal axes. In one example, the first sensor comprises and/or is an orientation sensor, adapted to sense an orientation of the user upon rotation about the 1, 2 or 3 mutually orthogonal axes. In this way, an orientation (i.e. direction) of the user may be determined and included in the simulated environment. This means that the user's physical orientation, as calculable by the first sensor or a plurality there of, for example positioned on the stirrups, can consistently be used to represent the user's rotational position and the direction they are facing in a VR landscape. Orientation sensors include inertial measurement units; gyroscopes; and accelerometers. In one example, a resistance of the pivot to rotation is adjustable, for example frictionally. In this way, the resistance to turning of the user may be customised.

In one example, the frame is assembled and/or fabricated using tubing, for example steel tubing, aluminium alloy tubing and/or composite tubing, such as GRP or CFT. In this way, the frame may be relatively strong while relatively light and hence capable of suspending a user while facilitate transportation. In one example, the tubing is telescopic. In this way, a height of the frame may be adjusted and/or the frame may be reduced, for example for storage and/or transportation.

In one example, the apparatus comprises a sling for suspending the harness from the frame.

### Apparatus

The second aspect provides an apparatus comprising:

a harness for suspending, at least in part, a user, wherein the harness comprises a set of straps, including a first strap, attachable to respective limbs of the user;
a set of actuators, including a first actuator, arranged to adjust respective lengths of the set of straps; and
a controller communicatively coupleable to a virtual reality, VR, headset of the user;
wherein the controller is configured to:
receive a set of input signals, including a first input signal, from the VR headset; and
control the first actuator to adjust a length of the first strap, responsive to the first input signal.

In this way, the user may move relatively freely whilst suspended in the harness, allowing the user to simulate moving in a simulated environment provided by the VR, as displayed by the VR headset of the user. For example, the user may turn their body as well as moving their head and/or limbs, thereby better replicating moving in the real-world environment. However, since the user is suspended in the harness, obstacles or dangers in the real-world environment are eliminated, thereby providing a safe simulated experience for the user. Furthermore, the harness includes the set of actuators, including the first actuator, arranged to adjust the length of the first strap responsive to the first input signal received from the VR headset, thereby providing input or feedback from the VR to the user. In this way, the experience provided by VR and/or interaction with the simulated environment thereof is enhanced for the user. Furthermore, the apparatus is relatively simple (i.e. having relatively few components or parts), thereby reducing a cost and/or complexity thereof. In one example, the apparatus consists of the harness, the set of actuators, optionally a set of sensors, the controller communicatively coupleable to the VR headset, a power supply and optionally, a frame. In this way, manufacture, distribution and storage of the apparatus is facilitated while use thereof is simplified. For example, the harness, having the set of actuators, controller and power supply attached thereto, may be stored conveniently by the user and subsequently, worn and used by the user.

The harness, the set of straps and/or the controller may be as described with respect to the first aspect. The apparatus, including any feature thereof, according to the second aspect may be combined with the apparatus, including any feature thereof, according to the first aspect and vice versa.

### Harness

The apparatus comprises the harness for suspending, at least in part, the user. It should be understood that the harness is suitable for suspending the user, for example from a suspension point such as a ceiling bracket. In one example, the harness comprises a waist or climbing harness, having an adjustable waistbelt and a pair of adjustable leg loops attached thereto. Waist harnesses are known. In one example, the harness comprises a full body harness, having an adjustable waistbelt and a pair of adjustable leg loops, a pair of shoulder straps and a optionally chest strap attached thereto. Full body harnesses are known. In contrast to a waist harness, a full body harness permits safe inversion of the user.

### Straps

The harness comprises the set of straps, including the first strap, attachable to the respective limbs of the user. It should be understood that the set of straps is different and separate from the leg loops of waist harnesses and full body harnesses. That is, the harness further comprises the set of straps, for example in addition to the leg loops. It should be understood that the set of straps is formed from a flexible material, for example webbing.

In one example, the set of straps includes a second strap and the first strap and the second strap are attachable to respective upper or lower limbs of the user. In this way, the first and second strap may be attached to the user's arms or the user's legs.

In one example, the set of straps is attachable proximal distal ends of the respective limbs (i.e. legs and/or arms) of the user, for example proximal or at the wrists and/or ankles of the user.

In one example, the set of straps includes the first strap and a second strap, attachable to respective wrists or ankles of the user. By attaching the set of straps to the wrists of the user, arm movements, including independent arm movements, of the user may be input into the VR, as described below. For example, throwing, catching and/or swimming of the suspended user may be input into the VR. By attaching the set of straps to the ankles of the user, leg movements, including independent leg movements, of the user may be input into the VR, as described below. For example, walking, running and/or jumping of the suspended user may be input into the VR. In one example, the set of straps includes the first strap, a second strap, a third strap and a fourth strap attachable to respective wrists and ankles of the user.

In one example, the first strap comprises one or more adjustable and/or releasable cuff(s), for attaching around a limb, for example a wrist, forearm and/or upper arm or an ankle, calf and/or thigh of the user.

In one example, the first strap comprises a stirrup, for the user's foot.

In one example:

the set of straps includes a second strap and wherein the first strap and the second strap are attachable to respective upper or lower limbs of the user;
the set of actuators includes a second actuator and wherein the first actuator and the second actuator are arranged to adjust respective lengths of the first strap and the second strap; and
the controller is configured to:
receive the set of input signals, including the first input signal and a second input signal, from the VR headset; and
control the second actuator to adjust a length of the second strap, responsive to the second input signal.

### Acutators

The apparatus comprises the set of actuators, including the first actuator, arranged to adjust the respective lengths of the set of straps. In this way, the respective lengths of the set of straps may be lengthened or shortened, thereby applying forces on the respective limbs of the user and hence enhancing the experience provided by the VR and/or interaction with the simulated environment thereof.

In one example, the first actuator comprises an electrical, a mechanical, a hydraulic and/or a pneumatic actuator. Electromechanical actuators are preferred.

In one example, the first actuator comprises a driven spool or cam, for example driven by a motor. In this way, lengthening and shortening of the first strap may be affected by rotation of the driven spool or cam. By rotating the driven spool can through multiple revolutions, the first strap may be successively lengthened and shortened. By rotating the driven cam through a partial revolution, the first strap may be incrementally lengthened and shortened. In this way, step simulation may be provided, as described below. In one example, the cam comprises and/or is an eccentric cam, an egg or oval cam or a snail cam, preferably a snail cam (i.e. a stepped cog).

In one example, the set of actuators is attached and/or integrated in the harness, for example in the set of straps.

### Step Simulation

In one example, the first actuator is actuated by an input signal, for example a feedback signal, from the VR when the user approaches a step up and/or a step down in the VR. In one example, the first actuator is actuated to lengthen the length of the respective strap (for example, by turning to short-side-out for a snail cam) for a step down in the VT and hence provide a sensation of stepping down. In one example, the first actuator is actuated to shorten the length of the respective strap (for example, by turning to wide-side-out for a snail cam) for a step down in the VT and hence provide a sensation of stepping down.

### Kneeling Simulation

In one example, the apparatus comprises a set of cables, including a first cable and optionally a second cable, attached to respective knees of the user, which are adjustable so that when the user drops to a kneeling position, for example on one or both knees, the respective cable becomes taut and creates resistance such that the user feels like they are kneeling on a solid surface. Hence, allowing the user to kneel in the harness and kneel in VR.

### Sensors

In one example, the apparatus comprises a set of sensors, including a first sensor, configured to output a set of output signals, including a first signal, related to the user; and wherein the controller is configured to transmit the set of output signals to the VR headset.

The set of sensors, the set of signals and/or the controller may be as described with respect to a first aspect.

It should be understood that the set of sensors is configured to sense a measurable physical property related to the user, including to the harness worn by the user.

In one example, the first sensor comprises and/or is a force sensor, adapted to sense a force applied, at least in part, by the user on the first strap. In this way, the force applied by the user on the first strap may be input into the VR. In this way, a speed of movement of the user resulting in the applied force may be calculated, for example by the controller and/or by the VR, whereby walking and running, for example, may be distinguished. In this way, interaction with the simulated environment may be improved. In one example, the force sensor or a plurality thereof is/are attached to respective stirrups and the sensed force(s) is/are used by the controller to calculate distance moved by a stride and/or jump height within a VR landscape. In one example, the first sensor comprises and/or is a position sensor, as described below. In one example, the position sensor or a plurality thereof is/are attached to respective stirrups and the sensed position(s) adapted to sense a distance (i.e. a stride length) moved by the user and/or a first limb thereof. In one example, the controller is configured to calculate new co-ordinates of, for example, the user's avatar in VR, for example by multiplying the force(s) sensed by the force sensor(s) and the stride length. Force sensors include force cells; piezoelectric sensors; and strain gauges.

In one example, the first sensor comprises and/or is a position sensor, adapted to sense a position of the user and/or a first limb thereof. In this way, a position of the user in the simulated environment may be determined, for example by translation from the real-world environment. By repeatedly sensing the position of the user and/or first limb thereof, movement of the user and/or first limb thereof may be determined and included in the simulated environment. Position sensors include capacitive displacement sensors, eddy-current sensors; Hall effect sensors; inductive sensors; laser Doppler vibrometers (optical); linear variable differential transformers (LVDT); photodiode arrays; piezo-electric transducers (piezo-electric); position encoders such as: absolute encoders, incremental encoders, linear encoders, and rotary encoders; potentiometers; proximity sensors (optical); string potentiometers; and ultrasonic sensors.

In one example, the first sensor comprises and/or is an orientation sensor, adapted to sense an orientation of the user and/or the first limb thereof. In this way, an orientation (i.e. direction) of the user and/or the first limb thereof may be determined and included in the simulated environment. Orientation sensors include inertial measurement units; gyroscopes; and accelerometers.

In one example, the first sensor comprises and/or is a movement sensor, adapted to sense a movement of the user and/or the first limb thereof. In this way, a movement of the user and/or the first limb thereof may be determined and included in the simulated environment. Movement sensors include inertial measurement units; gyroscopes; and accelerometers.

In one example, the set of sensors includes a plurality of force, position, orientation and/or movement sensors, for example for and/or associated with each strap of the set thereof. In this way, forces applied by the user on the straps by the respective limbs and/or positions, orientations and/or movements of the respective limbs maybe input into the VR.

In one example, the set of sensors includes a second sensor, wherein the second sensor comprises and/or is a position sensor, an orientation sensor and/or a movement sensor, adapted to sense a position, an orientation and/or a movement of a first limb of the user.

In one example, the set of sensors is attached and/or integrated in the harness, for example on and/or in the set of straps.

In one example, the controller is configured to transmit the set of output signals to the VR headset responsive to controlling the first actuator to adjust the length of the first strap. In this way, feedback from the apparatus to the VR headset in response to adjusting the length of the first strap may be provided, thereby allowing movement of the user to be distinguished, for example user running or walking up or down stairs.

### Controller

The apparatus comprises the controller communicatively coupleable to the VR headset of the user and the controller is configured to receive the set of input signals, including the first input signal, from the VR headset; and control the first actuator to adjust the length of the first strap, responsive to the first input signal. In this way, input or feedback from the VR may be provided to the VR. In this way, the experience provided by VR and/or interaction with the simulated environment thereof is enhanced for the user.

It should be understood that the controller is communicatively coupled, for example wirelessly or via wires, to the set of actuators, for example unidirectionally. In one example, the controller comprises a processor and a memory.

In one example, the controller is communicatively coupleable to the VR headset wirelessly, for example via Bluetooth, or via wires, for example using a USB cable, for example unidirectionally or bidirectionally.

In one example, the controller is configured to transmit a set of output signals to the VR, for example output by a set of sensors, as described above. In this way, the controller may transmit output signals to the VR headset to feedback from the user to the simulated environment, for example described above.

In one example, the controller includes a processor and a memory, an ASIC and/or a FPGA, configured to perform instructions to perform the methods according to the first aspect and/or the second aspect.

In one example, the controller is attached and/or integrated in the harness, for example on and/or in a waistbelt thereof.

### VR Headset

VR headsets are known. VR headsets include Oculus Quest®, Oculus Quest 2®, Oculus Rift®, Sony Playstation VR®, HTC Vive Cosmos®, Valve Index®, Windows Mixed Reality® and HP Reverb G2®. It should be understood that the VR headset generally comprises a display, for example a stereoscopic or an autosteroscopic display, communicatively coupled to a computer including a processor and a memory. It should be understood that the computer may be remote with respect to the display and that functions of the computer may be performed via a network, for example via client-server computing.

### Power Supply

In one example, the apparatus comprises a power supply, for example a battery, for providing electrical power to the sensors and/or the controller. In one example, the power supply is attached and/or integrated in the harness, for example on and/or in a waistbelt thereof. In one example, electrical power is obtained from the VR headset, for example via wires therefrom.

### Frame

In one example, the apparatus comprises a frame for suspending the harness therefrom, for example as described with respect to the first aspect. In this way, the user wearing the harness may be suspended from the frame c.f. suspended from an attachment point. In one example, the frame is arranged to allow the user to stand suspended above the ground and to lie suspended horizontally with arms outstretched. In one example, the frame has a height greater than or equal to that of the user, for example in a range from 1.5 m to 2.5 m. In this way, the user is suspended below, for example entirely below, a relatively higher suspension point or apex of the frame. In one example, the frame has a height less than that of the user, for example in a range from 1.0 m to 1.5 m. In this way, the user is suspended via the waist below a suspension point of the frame. It should be understood that the suspension point of the frame is above a centre of mass of the user.

In one example, the frame comprises a set of legs, for example 1, 2, 3, 4 or more legs. Generally, 3 or 4 legs are preferred, thereby reducing a complexity. In one example, the frame comprises one or more ties arranged to mutually tie the legs of the set thereof. In this way, structural integrity of the frame is improved.

In one example, the frame comprises and/or is a foldable or demountable frame. In this way, the frame may be folded or demounted for storage, for example.

In one example, the frame comprises a pivot, for example a freely rotating pivot, for rotation of the suspended harness about 1, 2 or 3 mutually orthogonal axes. In this way, the user may rotate, for example freely, about 1, 2 or 3 mutually orthogonal axes. In one example, the first sensor comprises and/or is an orientation sensor, adapted to sense an orientation of the user upon rotation about the 1, 2 or 3 mutually orthogonal axes. In this way, an orientation (i.e. direction) of the user may be determined and included in the simulated environment. This means that the user's physical orientation, as calculable by the first sensor or a plurality there of, for example positioned on the stirrups, can consistently be used to represent the user's rotational position and the direction they are facing in a VR landscape, Orientation sensors include inertial measurement units; gyroscopes; and accelerometers. In one example, a resistance of the pivot to rotation is adjustable, for example frictionally. In this way, the resistance to turning of the user may be customised.

In one example, the frame is assembled and/or fabricated using tubing, for example steel tubing, aluminium alloy tubing and/or composite tubing, such as GRP or CFT. In this way, the frame may be relatively strong while relatively light and hence capable of suspending a user while facilitate transportation. In one example, the tubing is telescopic. In this way, a height of the frame may be adjusted and/or the frame may be reduced, for example for storage and/or transportation.

In one example, the apparatus comprises a sling for suspending the harness from the frame.

### VR Headset

A third aspect provides virtual reality, VR, headset configured to transmit a set of input signals, including a first input signal, to an apparatus according to the first aspect and/or the second aspect.

The VR headset may be as described with respect to the first aspect/or the second aspect.

### Kit

A fourth aspect provides a kit comprising an apparatus according to the first aspect and/or the second aspect and a VR headset according to the third aspect.

In one example, the VR headset is configured to transmit the set of input signals, including the first input signal, to the controller, responsive to receiving the set of output signals therefrom, for example as described with respect to the first aspect and/or the second aspect.

### Method

The fifth aspect provides a method of virtual reality, VR, of an apparatus according to the first aspect, the method comprising:

outputting, by the set of sensors including the first sensor, the set of output signals, including the first signal; and
transmitting, by the controller, the set of output signals to the VR headset.

In this way, the set of output signals, relating to user movement, for example length, speed and angle of motion of feet and/or hands, transmitted to the VR headset may be used by software thereof to represent user actions, motions and/or gestures, for example walking, running, jumping, diving, swimming, flying motions, thereby enhancing the VR, particularly an interactive experience thereof.

The method may include any steps described with respect to the first aspect and/or the second aspect.

In one example, the method comprises calibrating the set of output signals, for example against predetermined actions related to the user. In this way, user actions, motions and/or gestures, for example walking, running, jumping, diving, swimming, flying motions, may be distinguished relatively more accurately. For example, if the user imposes relatively larger forces on foot straps, attached to the user's feet via respective foot stirrups, running may be inferred. Conversely, if the user imposes relatively smaller forces on the foot straps, walking may be inferred. For example, if the user imposes relatively lower frequency forces on the foot straps, relatively slower running or walking may be inferred. Conversely, if the user imposes relatively higher frequency forces on the foot straps, relatively faster running or walking may be inferred.

### Method

The sixth aspect provides a method of virtual reality, VR, of an apparatus according to the second aspect, the method comprising:

receiving, by the controller, the set of input signals, including the first input signal, from the VR headset; and
controlling, by the controller, the first actuator to adjust the length of the first strap, responsive to the first input signal.

In this way, by adjusting the length of the first strap, user actions, motions and/or gestures, for example walking, running, jumping, diving, swimming, flying motions, may be urged by the apparatus, thereby enhancing the VR, particularly an interactive experience thereof. For example, by alternately shortening and lengthening foot straps, attached to the user's feet via respective foot stirrups, walking or running may be urged. For example, by simultaneously lengthening foot straps while shortening hand straps, a falling experience may be provided. Conversely, by simultaneously shortening foot straps while lengthening hand straps, a jumping experience may be provided.

In one example, controlling, by the controller, the first actuator to adjust the length of the first strap, responsive to the first input signal, comprises simulating a motion of the user. in this way, by simulating the motion of the user, walking, running, jumping, diving, swimming and/or flying maybe simulated using the apparatus.

The method may include any steps described with respect to the first aspect and/or the second aspect.

### Computer, Computer Program, CRM

The seventh aspect computer comprising a processor and a memory configured to implement a method according to the fifth aspect and/or the sixth aspect, a computer program comprising instructions which, when executed by a computer comprising a processor and a memory, cause the computer to perform a method according to the fifth aspect and/or the sixth aspect, or a non-transient computer-readable storage medium comprising instructions which, when executed by a computer comprising a processor and a memory, cause the computer to perform a method according to the fifth aspect and/or the sixth aspect.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1A schematically depicts a front perspective view of an apparatus according to an exemplary embodiment; and FIG. 1B schematically depicts a rear perspective view of the apparatus;

FIG. 2A schematically depicts a front perspective view of an apparatus according to an exemplary embodiment; and FIG. 2B schematically depicts a rear perspective view of the apparatus;

FIG. 3A schematically depicts a front perspective view of an apparatus according to an exemplary embodiment; and FIG. 3B schematically depicts a rear perspective view of the apparatus;

FIG. 4 schematically depicts an actuator for an apparatus according to an exemplary embodiment;

FIG. 5 schematically depicts a method according to an exemplary embodiment; and

FIG. 6 schematically depicts a method according to an exemplary embodiment.

### DETAILED DESCRIPTION OF THE DRAWINGS

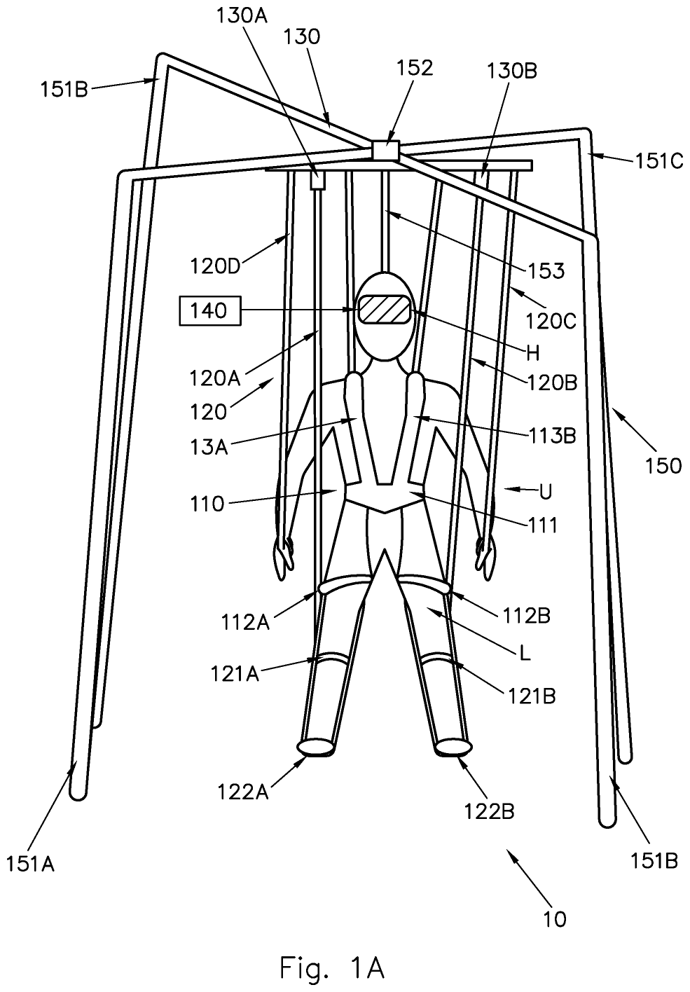

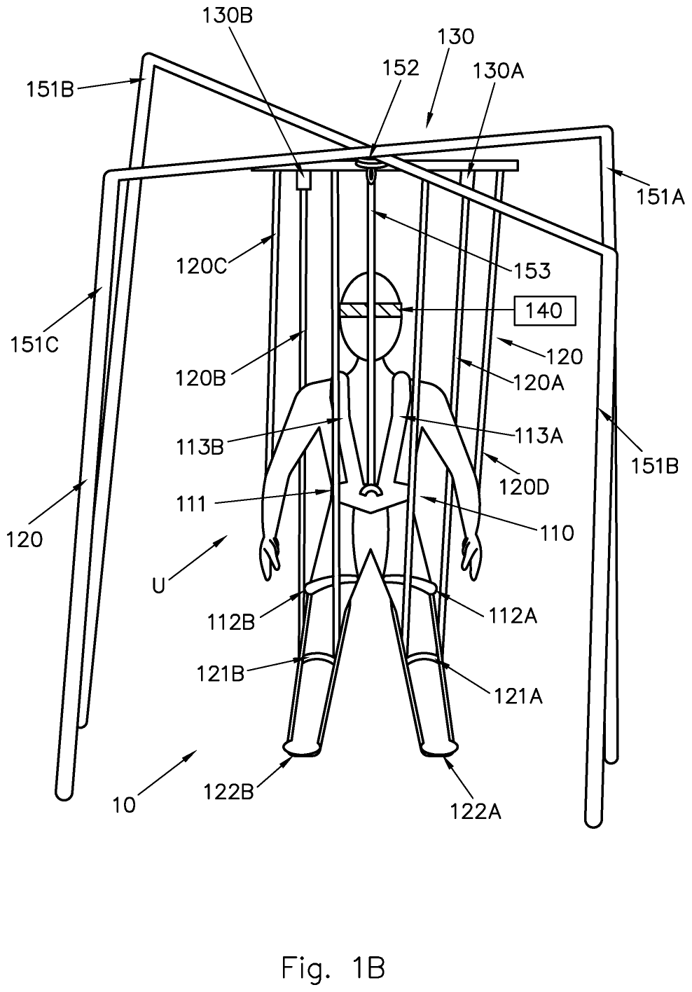

FIG. 1A schematically depicts a front perspective view of an apparatus 10 according to an exemplary embodiment; and FIG. 1B schematically depicts a rear perspective view of the apparatus 10.

The apparatus 10 comprises:

a harness 110 for suspending, at least in part, a user U, wherein the harness 110 comprises a set of straps 120, including a first strap 120A, attachable to respective limbs L of the user U;
a set of sensors 130, including a first sensor 130A, configured to output a set of output signals, including a first signal, related to the user U; and
a controller 140 communicatively coupleable to a virtual reality, VR, headset H of the user U;
wherein the controller 140 is configured to:
to transmit the set of output signals to the VR headset H.

In this example, the harness 110 comprises a full body harness 110, having an adjustable waistbelt 111 and a pair of adjustable leg loops 112A, 112B and a pair of shoulder straps 113A, 113B attached thereto.

In this example, the set of straps 120 includes a second strap 120B and the first strap 120A and the second strap 120B are attachable to respective lower limbs L of the user U. In this example, the first strap 120A comprises an adjustable and/or releasable cuff 121A, for attaching to a limb, for example a wrist or an ankle, of the user U. In this example, the first strap 120A comprises a stirrup 122A, for the user's foot.

In this example, the first sensor 130A is a force sensor, adapted to sense a force applied, at least in part, by the user U on the first strap 120A. In this example, the set of sensors 130 includes a plurality of force, position, orientation and/or movement sensors 130, for and/or associated with each strap 120A, 120B of the set thereof. In this example, the set of sensors 130 is integrated in the harness 110, in the set of straps 120. In this example, the controller 140 is configured to calculate distance moved by a stride and/or jump height within a VR landscape. In this example, the controller 140 is configured to calculate new co-ordinates of, for example, the user's avatar in VR, for example by multiplying the force(s) sensed by the force sensor(s) and the stride length.

In this example, the controller 140 is communicatively coupleable to the VR headset H wirelessly, via Bluetooth, bidirectionally.

In this example, the VR headset H is an Oculus Quest 2.

In this example, the apparatus 10 comprises a power supply (not shown).

In this example, the apparatus 10 comprises a frame 150 for suspending the harness 110 therefrom. In this example, the frame 150 comprises a set of 4 legs 151A, 151B, 151C, 151D. In this example, the frame 150 comprises a pivot 152, for example a freely rotating pivot, for rotation of the suspended harness 110 about 1 axis. In this example, the set of sensors 130 includes a second sensor 130B (not shown) wherein the second sensor 130B is an orientation sensor, adapted to sense an orientation of the user upon rotation about the 1 axis. In this way, an orientation (i.e. direction) of the user may be determined and included in the simulated environment.

In this example, the apparatus 10 comprises a sling 153 for suspending the harness 110 from the frame 150.

In more detail, the two foot stirrups 122A, 122B attached via webbing straps 120A, 120B to newton meters (i.e. set of sensors 1300) to a strong bar (i.e. frame 150) prefixed with a rotating cuff (i.e. pivot 152) allowing 360 degree horizontal spin, with adjustable resistance to customise for user turning, from which the user U is suspended via the harness 110 and waist-level strap 111. Hand straps 120C, 120D for support also hang from the bar. The rotating bar can be hung from a suitably strong ceiling beam or from a four-legged frame, which is of sufficient scale to allow a person to stand suspended above the ground and to lie suspended horizontally with arms outstretched from the waist-level strap.

The stirrups 122A, 122B are secured each side of the upper calf via a calf-level belt 121A, 121B. The waist level strap 111 is of sufficient strength to suspend the user U should they lift their weight from the foot stirrups 122A, 122B. The supporting hand straps 120C, 120D are also strong enough to support the upper body in a horizontal position.

In this example, there is a one-way feedback from the user's harness 110 to the VR headset H in the following ways:
Data from the accelerometers and newton meters (i.e. the set of sensors) is collated in a computer (i.e. the controller 140) to represent length, speed and angle of motion of feet and hands. This is calibrated to emulate walk, run, jump, dive, swim, fly motions which can be read by the VR game software via an API.

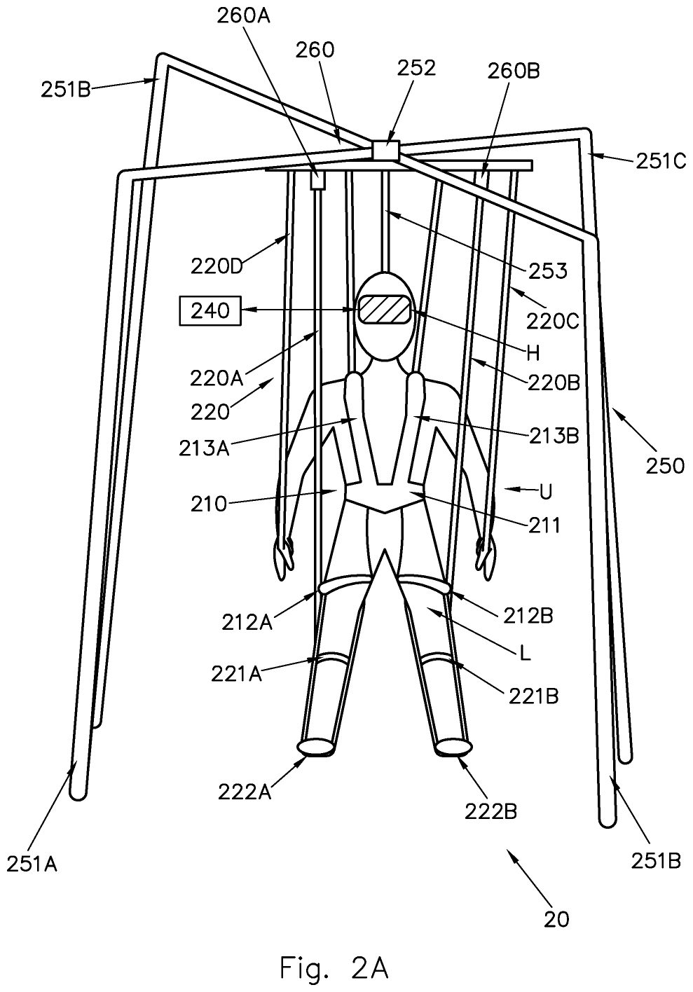

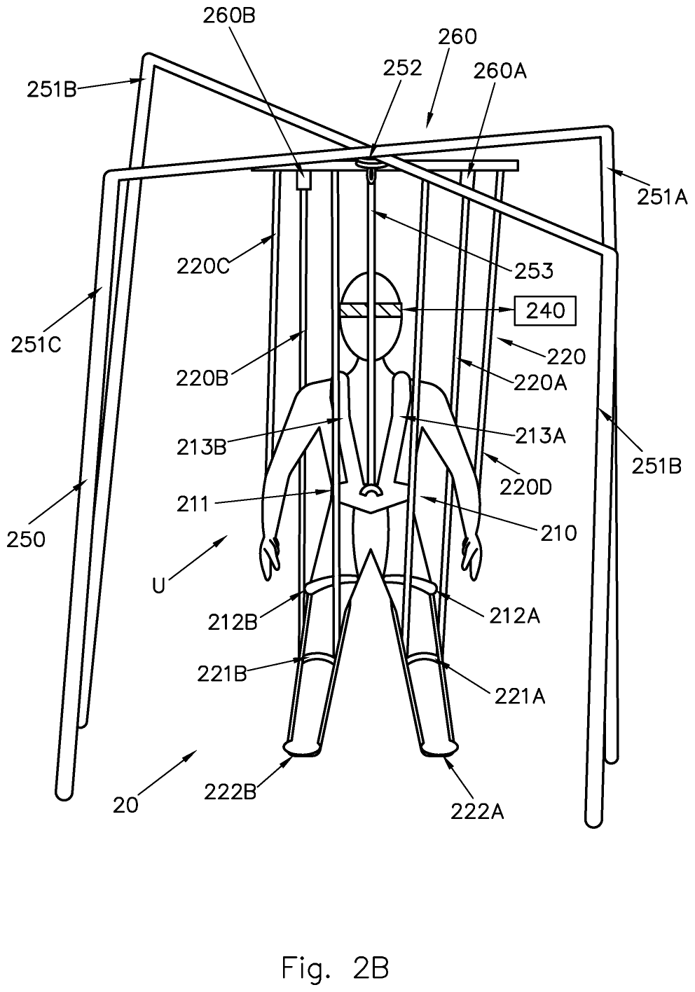

FIG. 2A schematically depicts a front perspective view of an apparatus 20 according to an exemplary embodiment; and FIG. 2B schematically depicts a rear perspective view of the apparatus 20.

The apparatus 20 comprises:

a harness 210 for suspending, at least in part, a user U, wherein the harness 210 comprises a set of straps 220, including a first strap 220A, attachable to respective limbs L of the user U;
a set of actuators 260, including a first actuator 260A, arranged to adjust respective lengths of the set of straps 220; and
a controller 240 communicatively coupleable to a virtual reality, VR, headset H of the user U;
wherein the controller 240 is configured to:
receive a set of input signals, including a first input signal, from the VR headset H; and
control the first actuator 260A to adjust a length of the first strap 220A, responsive to the first input signal.

In this example, the harness 210 comprises a full body harness 210, having an adjustable waistbelt 211 and a pair of adjustable leg loops 212A, 212B and a pair of shoulder straps 213A, 213B attached thereto.

In this example, the set of straps 220 includes a second strap 220B and the first strap 220A and the second strap 220B are attachable to respective lower limbs L of the user U. In this example, the first strap 220A comprises an adjustable and/or releasable cuff 221A, for attaching to a limb, for example a wrist or an ankle, of the user U. In this example, the first strap 220A comprises a stirrup 222A, for the user's foot.

In this example, the controller 240 is communicatively coupleable to the VR headset H wirelessly, via Bluetooth, bidirectionally.

In this example, the VR headset H is an Oculus Quest 2.

In this example, the apparatus 20 comprises a power supply (not shown).

In this example, the apparatus 20 comprises a frame 250 for suspending the harness 210 therefrom. In this example, the frame 250 comprises a set of 4 legs 251A, 251B, 2510, 251D. In this example, the frame 250 comprises a pivot 252 for rotation of the suspended harness 210 about 1 axis. In this example, the set of sensors 230 includes a second sensor 230B (not shown) wherein the second sensor 230B is an orientation sensor, adapted to sense an orientation of the user upon rotation about the 1 axis. In this way, an orientation (i.e. direction) of the user may be determined and included in the simulated environment.

In this example, the apparatus 20 comprises a sling 253 for suspending the harness 210 from the frame 250.

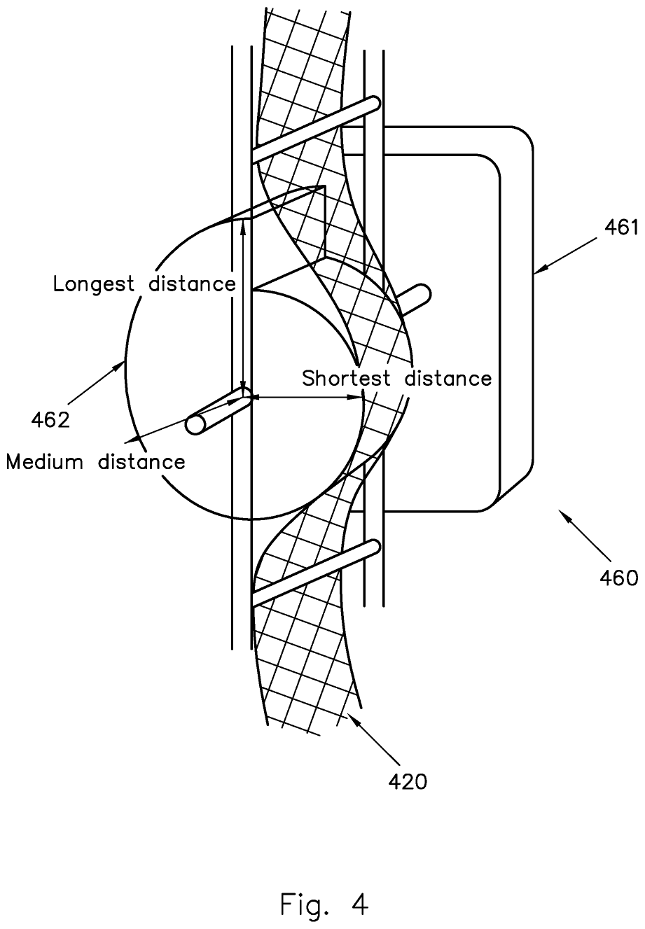

In more detail, the two foot stirrups 222A, 222B attached via webbing straps 220A, 220B over a “step simulator” (i.e. set of actuators 260) (as described with respect to FIG. 4) to a strong bar (i.e. frame 250) prefixed with a rotating cuff (i.e. pivot 252) allowing 360 degree horizontal spin, with adjustable resistance to customise for user turning, from which the user is suspended via a harness and waist-level strap. Hand straps 220C, 220D for support also hang from the bar. The rotating bar can be hung from a suitably strong ceiling beam or from a four-legged frame, which is of sufficient scale to allow a person to stand suspended above the ground and to lie suspended horizontally with arms outstretched from the waist-level strap.

The stirrups 222A, 222B are secured each side of the upper calf via a calf-level belt 221A, 221B. The waist level strap 211 is of sufficient strength to suspend the user U should they lift their weight from the foot stirrups 222A, 222B. The supporting hand straps 220C, 220D are also strong enough to support the upper body in a horizontal position.

There is a one-way feedback from the user's VR headset H to the apparatus 20 in the following ways:
VR game software can communicate a “step” in the landscape to the step simulator via an API, causing the step simulator to spin clockwise (step up) or anticlockwise (step down). This will represent to the user's senses the feeling of stepping up or down, for example as described previously.

In this example, the first actuator 260A comprises a driven spool or cam, as described above, preferably a snail cam, actuated by an input signal, for example a feedback signal, from the VR when the user approaches a step up and/or a step down in the VR. In this example, the first actuator 260A is actuated to lengthen the length of the respective strap (for example, by turning to short-side-out for a snail cam) for a step down in the VT and hence provide a sensation of stepping down. In this example, the first actuator 260A is actuated to shorten the length of the respective strap (for example, by turning to wide-side-out for a snail cam) for a step down in the VT and hence provide a sensation of stepping down.

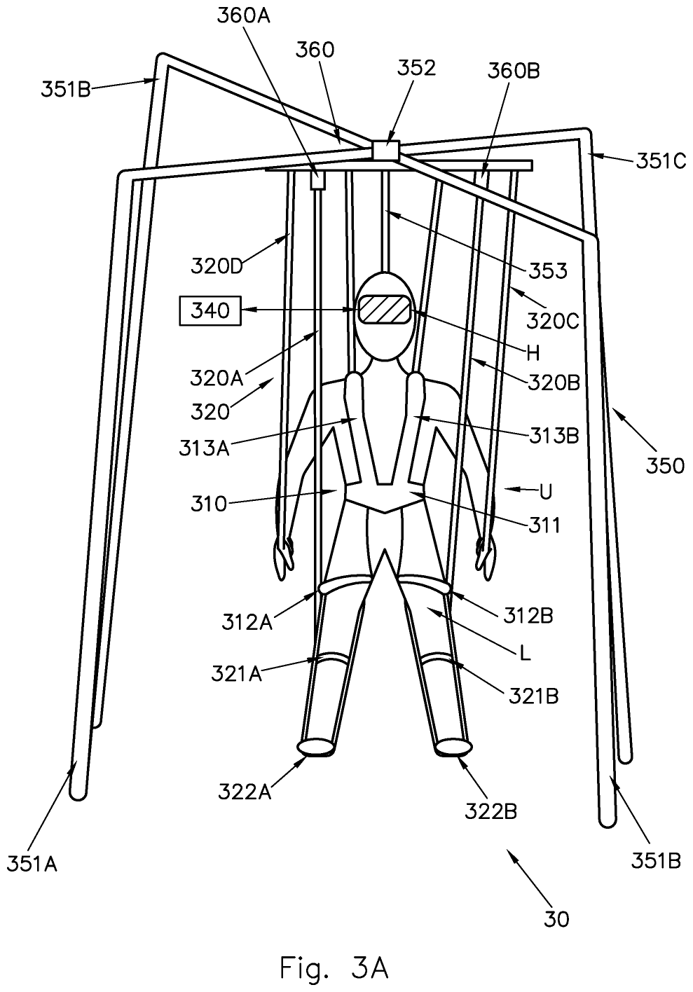

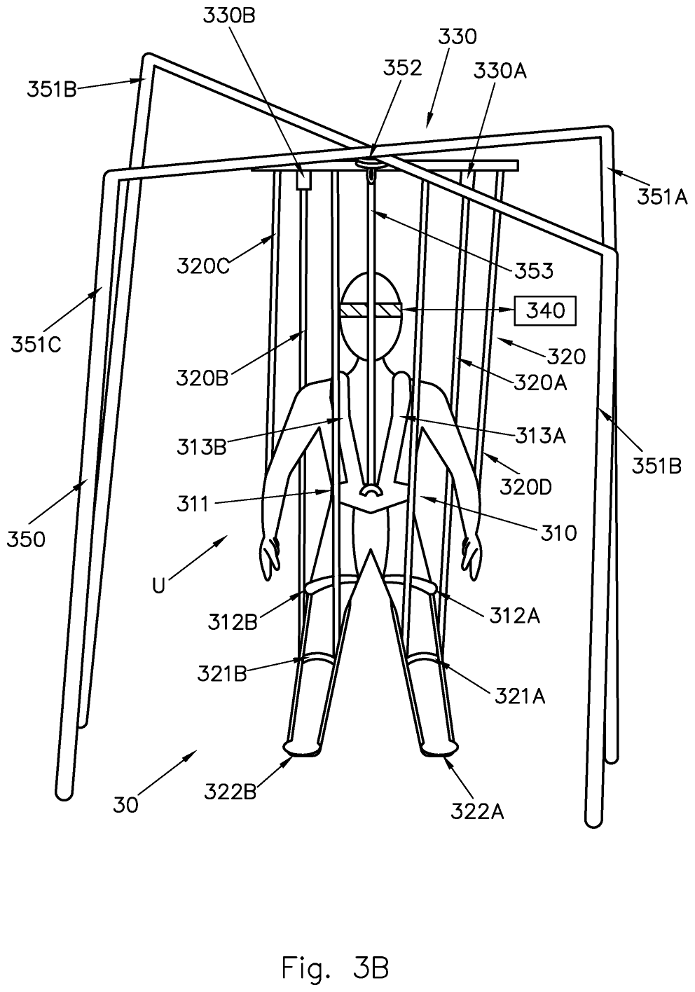

FIG. 3A schematically depicts a front perspective view of an apparatus 30 according to an exemplary embodiment; and FIG. 3B schematically depicts a rear perspective view of the apparatus 30.

The apparatus 30 comprises:

a harness 310 for suspending, at least in part, a user U, wherein the harness 310 comprises a set of straps 320, including a first strap 320A, attachable to respective limbs L of the user U;
a set of actuators 360, including a first actuator 360A, arranged to adjust respective lengths of the set of straps 320; and
a controller 340 communicatively coupleable to a virtual reality, VR, headset H of the user U;
wherein the controller 340 is configured to:
receive a set of input signals, including a first input signal, from the VR headset H; and
control the first actuator 350A to adjust a length of the first strap 320A, responsive to the first input signal.

In this example, the harness 310 comprises a full body harness 310, having an adjustable waistbelt 311 and a pair of adjustable leg loops 312A, 312B and a pair of shoulder straps 313A, 313B attached thereto.

In this example, the set of straps 320 includes a second strap 320B and the first strap 320A and the second strap 320B are attachable to respective lower limbs L of the user U. In this example, the first strap 320A comprises an adjustable and/or releasable cuff 321A, for attaching to a limb, for example a wrist or an ankle, of the user U. In this example, the first strap 320A comprises a stirrup 322A, for the user's foot.

In this example, the apparatus 30 comprises a set of sensors 330 (not shown), including a first sensor 330A, configured to output a set of output signals, including a first signal, related to the user U, generally as described with respect to the apparatus 10. In this example, the first sensor 330A is a force sensor, adapted to sense a force applied, at least in part, by the user U on the first strap 320A. In this example, the set of sensors 330 includes a plurality of force, position, orientation and/or movement sensors 330, for and/or associated with each strap 320A, 320B of the set thereof. In this example, the set of sensors 330 is integrated in the harness 310, in the set of straps 320. In this example, the controller 340 is configured to calculate distance moved by a stride and/or jump height within a VR landscape. In this example, the controller 340 is configured to calculate new co-ordinates of, for example, the user's avatar in VR, for example by multiplying the force(s) sensed by the force sensor(s) and the stride length.

In this example, the controller 340 is communicatively coupleable to the VR headset H wirelessly, via Bluetooth, bidirectionally.

In this example, the VR headset H is an Oculus Quest 3.

In this example, the apparatus 30 comprises a power supply (not shown).

In this example, the apparatus 30 comprises a frame 350 for suspending the harness 310 therefrom. In this example, the frame 350 comprises a set of 4 legs 351A, 351B, 351C, 351D. In this example, the frame 350 comprises a pivot for rotation 352 of the suspended harness 310 about 1 axis. In this example, the set of sensors 330 includes a second sensor 330B (not shown) wherein the second sensor 330B is an orientation sensor, adapted to sense an orientation of the user upon rotation about the 1 axis. In this way, an orientation (i.e. direction) of the user may be determined and included in the simulated environment.

In this example, the apparatus 30 comprises a sling 353 for suspending the harness 310 from the frame 350.

In more detail, the two foot stirrups 322A, 322B attached via webbing straps 320A, 320B, to newton meters (i.e. set of sensors 330), over a “step simulator” (i.e. set of actuators 360) (as described with respect to FIG. 4) to a strong bar (i.e. frame 350) prefixed with a rotating cuff allowing 360 degree horizontal spin, with adjustable resistance to customise for user turning, from which the user U is suspended via the harness 310 and waist-level strap 311. Hand straps 320C, 320D for support also hang from the bar. The rotating bar can be hung from a suitably strong ceiling beam or from a four-legged frame (i.e. the frame 250), which is of sufficient scale to allow a person to stand suspended above the ground and to lie suspended horizontally with arms outstretched from the waist-level strap.

The stirrups 322A, 322B are secured each side of the upper calf via a calf-level belt 321A, 321B. The waist level strap 311 is of sufficient strength to suspend the user U should they lift their weight from the foot stirrups 322A, 322B. The supporting hand straps 320C, 320D are also strong enough to support the upper body in a horizontal position.

Accelerometers (i.e. set of sensors 330) are attached to the foot level of the stirrups 322A, 322B and to the hand level of the hand straps 320C, 320D. There is a two-way feedback loop between the user's VR headset and the harness in the following ways:
Data from the accelerometers and newton meters (i.e. set of sensors 330) is collated in a computer (i.e. the controller 340) to represent length, speed and angle of motion of feet and hands. This is calibrated to emulate walk, run, jump, dive, swim, fly motions which can be read by the VR game software via an API.
VR game software can communicate a “step” in the landscape to the step simulator (i.e. the set of actuators 360) via an API, causing the step simulator to spin clockwise (step up) or anticlockwise (step down) on relaxation of the newton meter reading. This will represent to the user's senses the feeling of stepping up or down.

In this example, the first actuator 360A comprises a driven spool or cam, as described above, preferably a snail cam, actuated by an input signal, for example a feedback signal, from the VR when the user approaches a step up and/or a step down in the VR. In this example, the first actuator 360A is actuated to lengthen the length of the respective strap (for example, by turning to short-side-out for a snail cam) for a step down in the VT and hence provide a sensation of stepping down. In this example, the first actuator 360A is actuated to shorten the length of the respective strap (for example, by turning to wide-side-out for a snail cam) for a step down in the VT and hence provide a sensation of stepping down.

FIG. 4 schematically depicts an actuator 460 for an apparatus according to an exemplary embodiment.

When the motor 461 turns the wheel (i.e. a snail cam) 462 clockwise, the wider portion of the wheel 462 comes into contact with the strap 420—shortening the strap 420 and raising the user's foot. When turned anticlockwise, the narrower portion of the wheel 462 creates a longer strap and the sensation of stepping down. On a simulated “flat” VR surface the wheel reverts to a position with the medium-sized side portions of the wheel adjacent to the strap.

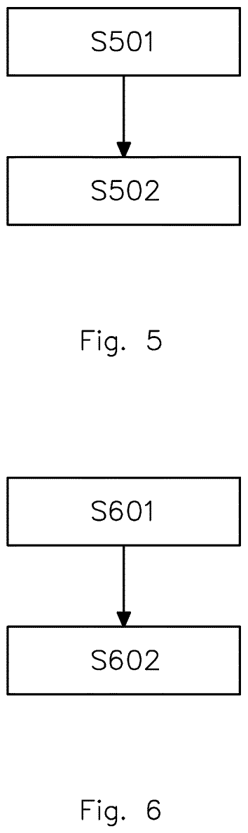

FIG. 5 schematically depicts a method according to an exemplary embodiment.

The method is of virtual reality, VR, of an apparatus according to the first aspect.

At S501, the method comprises outputting, by the set of sensors including the first sensor, the set of output signals, including the first signal.

At S502, the method comprises transmitting, by the controller, the set of output signals to the VR headset.

The method may include any of the steps as described with respect to the first aspect and/or the second aspect.

FIG. 6 schematically depicts a method according to an exemplary embodiment.

The method is of virtual reality, VR, of an apparatus according to the second aspect.

At S601, the method comprises receiving, by the controller, the set of input signals, including the first input signal, from the VR headset.

At S602, the method comprises controlling, by the controller, the first actuator to adjust the length of the first strap, responsive to the first input signal.

The method may include any of the steps as described with respect to the first aspect and/or the second aspect.

Although a preferred embodiment has been shown and described, it will be appreciated by those skilled in the art that various changes and modifications might be made without departing from the scope of the invention, as defined in the appended claims and as described above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or

Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. An apparatus comprising:
a harness for suspending, at least in part, a user, wherein the harness comprises a set of straps, including a first strap, attachable to respective limbs of the user;
a controller communicatively coupleable to a virtual reality, VR, headset of the user;
a set of sensors, including a first sensor, configured to output a set of output signals, including a first signal, related to the user; and/or
a set of actuators, including a first actuator, arranged to adjust respective lengths of the set of straps;
wherein the controller is configured to:
transmit the set of output signals to the VR headset; and/or
receive a set of input signals, including a first input signal, from the VR headset; and
control the first actuator to adjust a length of the first strap, responsive to the first input signal.

2. The apparatus according to claim 1;
wherein the set of straps includes a second strap and wherein the first strap and the second strap are attachable to respective upper or lower limbs of the user;
wherein the set of actuators includes a second actuator and wherein the first actuator and the second actuator are arranged to adjust respective lengths of the first strap and the second strap; and
wherein the controller is configured to:
receive the set of input signals, including the first input signal and a second input signal, from the VR headset; and
control the second actuator to adjust a length of the second strap, responsive to the second input signal.

3. The apparatus according to claim 1, wherein the first actuator is actuated by the first input signal from the VR when the user approaches a step up and/or a step down in the VR.

4. The apparatus according to claim 1, wherein the set of straps is attachable proximal distal ends of the respective limbs of the user.

5. The apparatus according to claim 1, wherein the set of straps is attachable proximal distal ends of the respective limbs of the user.

6. The apparatus according to claim 1, wherein the first actuator comprises an electrical, a mechanical, a hydraulic and/or a pneumatic actuator.

7. The apparatus according to claim 1, wherein the first actuator comprises a driven spool or cam.

8. The apparatus according to claim 1, wherein the first sensor comprises and/or is a force sensor, adapted to sense a force applied, at least in part, by the user on the first strap.

9. The apparatus according to claim 1, wherein the controller is configured to calculate a distance moved by a stride and/or jump height of the user using the sensed force.

10. The apparatus according to claim 1, wherein the set of sensors includes a second sensor, wherein the second sensor comprises and/or is a position sensor, an orientation sensor and/or a movement sensor, adapted to sense a position, an orientation and/or a movement of a first limb of the user.

11. The apparatus according to claim 1, wherein the controller is configured to transmit the set of output signals to the VR headset responsive to controlling the first actuator to adjust the length of the first strap.

12. The apparatus according to claim 1, comprising a frame for suspending the harness therefrom.

13. The apparatus according to claim 12, wherein the frame comprises a pivot for rotation of the suspended harness about 1, 2 or 3 mutually orthogonal axes.

14. The apparatus according to claim 13, wherein the first sensor comprises and/or is an orientation sensor, adapted to sense an orientation of the user upon rotation about the 1, 2 or 3 mutually orthogonal axes.

15. A virtual reality, VR, headset configured to transmit a set of input signals, including a first input signal, to an apparatus according to claim 1.

16. A kit comprising an apparatus according to claim 1 and a VR headset configured to transmit a set of input signals, including a first input signal, to the apparatus.

17. The kit according to claim 16, wherein the VR headset is configured to transmit the set of input signals, including the first input signal, to the controller, responsive to receiving the set of output signals therefrom.

18. A method of virtual reality, VR, of an apparatus according to claim 1, the method comprising:
outputting, by the set of sensors including the first sensor, the set of output signals, including the first signal; and
transmitting, by the controller, the set of output signals to the VR headset;
and/or
receiving, by the controller, the set of input signals, including the first input signal, from the VR headset; and
controlling, by the controller, the first actuator to adjust the length of the first strap, responsive to the first input signal.

19. A non-transient computer-readable storage medium comprising instructions which, when executed by a computer comprising a processor and a memory, cause the computer to perform a method according to claim 18.
